(19) United States
(12) Patent Application Publication
(10) Pub. No.: US 2019/0150036 A1
(43) Pub. Date: May 16, 2019

(54) DISTRIBUTED LEDGER SYSTEM FOR MANAGEMENT OF EXCHANGES OF WIRELESS SERVICES BETWEEN WIRELESS SERVICE PROVIDERS

(71) Applicant: Geoverse, LLC, Sammamish, WA (US)

(72) Inventors: Roderick Nelson, Sammamish, WA (US); Carl Gunell, Sammamish, WA (US); Dan Westin, Sammamish, WA (US)

(21) Appl. No.: 16/192,629

(22) Filed: Nov. 15, 2018

Related U.S. Application Data
(60) Provisional application No. 62/586,986, filed on Nov. 16, 2017.

(51) Int. Cl. H04W 28/24; H04W 28/18; H04W 28/26; H04W 72/04; H04L 12/24; H04L 9/06; H04W 4/02

(52) U.S. Cl. CPC H04W 28/24; H04W 28/18; H04W 28/26; H04W 72/0406; H04L 2209/38; H04L 41/5029; H04L 9/0643; H04W 4/025; H04L 41/5019

(57) ABSTRACT

The present disclosure is directed to using distributed ledger architectures and cryptocurrencies to enable creation and execution of service agreements between wireless service providers for provisioning of wireless communication resources. In one example, a distributed ledger system includes a plurality of nodes, each of which is configured to receive a service broadcast message from a corresponding first wireless service provider for an exchange of wireless communication services with a second wireless service provider; enable negotiation of terms and conditions of the exchange between the first wireless service provider and the second wireless service provider; generate a recording of the terms and conditions of the exchange to yield an agreement; record the agreement on the distributed ledger system; detect a triggering condition for executing the terms and conditions; execute the terms and conditions upon detecting the triggering condition; and automatically settle the exchange using a cryptocurrency.

### CROSS-REFERENCE TO RELATED APPLICATIONS

This application claims priority to U.S. Provisional Patent Application No. 62/586,986 filed on Nov. 16, 2017, the entire content of each of which is incorporated herein by reference.

### BACKGROUND

### Field of the Disclosure

The present disclosure relates to using distributed ledger architectures and cryptocurrencies to enable creation and execution of service agreements between wireless service providers for provisioning of wireless communication resources.

### Description of the Related Art

Various generations of wireless technologies and supporting networks have been designed, standardized, implemented and used globally to service millions/billions of end users. These wireless networks have evolved from analog to digital radio access systems, from circuit switching to packet core, from proprietary mobility and administrative protocols to standardized protocols, and from single provider to multi provider networks.

The continuous evolution of these networks to cover as large of a geographical area as possible and serve as many users as possible, as well as the continuous evolution of collaboration and interaction between diverse access methods have added complexities to administration of end users' mobility across different wireless networks. In other words, administration of roaming of end users from one wireless network to another has created complex technical and business administration problems.

Typically, these administration challenges are handled by various types of back office administrative functions for collecting information from their network and information received from each partner network on which a user device has roamed. With each network implementing such administrative functions, not only wireless network providers costs and overhead are increased, the management also requires use of network resources that can otherwise be dedicated to improve services provided to end users.

One can readily understand that this problem can only be exacerbated as more and more fully independent and autonomous networks come online and provide services to end users. Manual administration and management of roaming services across hundreds or thousands (and possibly millions) of wireless networks would be time consuming and cost prohibitive.

Furthermore, agreed upon pricing of roaming services between providers of wireless networks can vary slowly between any two groups of wireless network providers and do not dynamically take into account that a cellular network is not homogenous in its value across location and time. The result of this slow-moving process is lost value opportunity for both the provider and consumer of roaming services across wireless networks. In other words, sellers are not rewarded for the unique value they may have in portions of their network and buyers may be overpaying in some cases.

Therefore, a platform that provides for an efficient, automatic and transparent creation and settlement of services between wireless service providers is needed.

### SUMMARY

One or more example embodiments of inventive concepts are directed to using distributed ledger architectures and cryptocurrencies to enable creation and execution of service agreements between wireless service providers for provisioning of wireless communication resources.

One aspect of the present disclosure is a distributed ledger system for facilitating an exchange among wireless service providers. The distributed ledger system includes a plurality of wireless service providers, each wireless service provider being one of a home wireless network provider having a corresponding number of end users or a visited wireless network provider having wireless communication capacities for one or more of the end users to roam on; and a plurality of nodes, each of which is associated with one or more of the plurality of wireless service providers. Each of the plurality of nodes is configured to receive a service broadcast message from a corresponding first wireless service provider for an exchange of wireless communication services with a second wireless service provider; enable negotiation of terms and conditions of the exchange between the first wireless service provider and the second wireless service provider; generate a recording of the terms and conditions of the exchange between the first service provider and the second service provider to yield an agreement; record the agreement on the distributed ledger system; detect a triggering condition for executing the terms and conditions; execute the terms and conditions upon detecting the triggering condition; and automatically settle the exchange using a cryptocurrency.

One aspect of the present disclosure is distributed ledger system for facilitating an exchange among wireless service providers. The system includes one or more servers to which plurality of service providers subscribe. The one or more servers are configured to execute computer-readable instructions to enable a first service provider to broadcast a message requesting information on available service providers in a geographical region for offloading user traffic of the first service provider thereon, the message including offered terms for the exchange; enable a second service provider within the geographical region to respond to the message to (1) accept the offered terms or (2) provide alternative terms for the exchange; and a server configured to execute an application to: finalize mutually agreed upon terms of the exchange between the first service provider and the second service provider; generate a recording of the mutually agreed upon terms to yield an agreement; record the agreement on the distributed ledger system; detect a triggering condition for executing the terms and conditions; execute the terms and conditions upon detecting the triggering condition; and automatically settle the exchange using a cryptocurrency.

One aspect of the present disclosure includes one or more non-transitory computer-readable media having computer-readable instructions, which when executed by one or more processors, cause the one or more processors to provide a distributed ledger platform for automating service exchanges between one or more of a plurality of service providers by broadcasting, by a first service provider, a message requesting information on available service providers in a geographical region for offloading user traffic of the first service provider thereon, the message including offered terms for the exchange; enabling a second service provider within the geographical region to respond to the message to (1) accept the offered terms or (2) provide alternative terms for the exchange; finalizing mutually agreed upon terms of the exchange between the first service provider and the second service provider; generating a recording of the mutually agreed upon terms to yield an agreement; recording the agreement on the distributed ledger system; detecting a triggering condition for executing the terms and conditions; executing the terms and conditions upon detecting the triggering condition; and automatically settling the exchange using a cryptocurrency.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates an example ecosystem of home networks, visited networks and end users;

FIG. 2A is an illustrative block diagram of interconnection of components of ecosystem of FIG. 1 for exchange of services;

FIG. 2B is an illustrative block diagram of interconnection of components of ecosystem of FIG. 1 for exchange of services;

FIG. 3 is an example method of creating, managing and settlement of wireless service exchanges between two or more wireless network providers; and

FIG. 4 illustrates example components of a node of FIGS. 2A-B.

### DETAILED DESCRIPTION

Specific details are provided in the following description to provide a thorough understanding of embodiments. However, it will be understood by one of ordinary skill in the art that embodiments may be practiced without these specific details. For example, systems may be shown in block diagrams so as not to obscure the embodiments in unnecessary detail. In other instances, well-known processes, structures and techniques may be shown without unnecessary detail in order to avoid obscuring embodiments.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

Example embodiments of the present disclosure will be described more fully hereinafter with reference to the accompanying drawings in which like numerals represent like elements throughout the several figures, and in which example embodiments are shown. Example embodiments of the claims may, however, be embodied in many different forms and should not be construed as limited to the example embodiments set forth herein. The examples set forth herein are non-limiting examples and are merely examples among other possible examples.

Wireless network service providers (may also be referred to as wireless telecommunication service providers) participate in a wholesale marketplace, or ecosystem, for the purchase or sale (exchange) of wireless network capacity between them such that end users of one provider can roam, according to the agreed upon terms of such exchange. This process is sometimes referred to as roaming between networks where end users of a “home” network use the “visited” network's capacity and resources while traveling. The home network purchases this capacity at wholesale from the visited network. The home network then retails the service to their end users. Buyers may be sellers at the same time in different locations or for different uses. Sellers must operate, or be the managing entity, of wireless networks but buyers can have end users without necessarily having their own networks.

Administration and management of such agreements (wholesale agreements) between any two wireless network providers become more difficult as the number of available service providers increase. Furthermore, each network provider may need to allocate more network resources to such administration and management, which may come at the expense of having less network resources available for servicing end users. Hereinafter, example embodiments will be described according to which a distributed ledger system will be utilized to create, manage and record smart contracts that memorialize terms and conditions of an agreement or exchange between two service providers for roaming services followed by automatic execution and settlement of such exchanges without the need for dedicated network resources to such management and execution of exchanges as currently implemented by service providers.

Furthermore, as noted above, currently third party clearing houses handle, partially or entirely, management of exchanges of wireless services between wireless service providers. This management and communication with various parties to such exchanges require significant network infrastructure, servers, databases, etc. on behalf of the wireless service providers and the clearing houses. The concepts described in this application provide means and techniques to do away with such clearing houses and thus reduce network resource usage in managing exchanges by providing less centralized and more peer to peer schemes for exchange management.

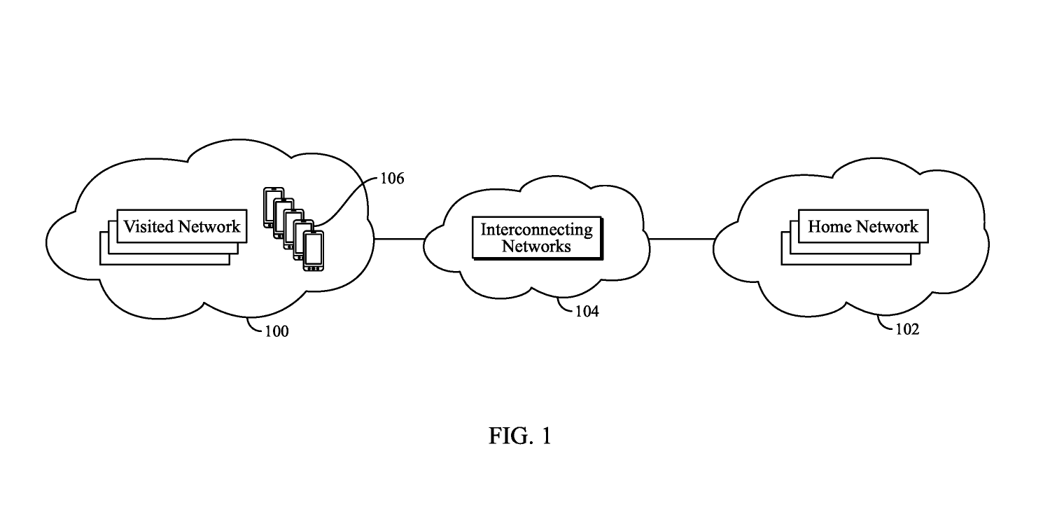

FIG. 1 illustrates a diagram depicting multiple wireless networks where the users of one network may use the services of another network. As shown in FIG. 1, wireless networks and corresponding providers may be split into two groups, one of which may form a visited networks group 100 and another one of which may be a home networks group 102. Visited networks group 100 and home networks group 102 may communicate via any known or to be developed interconnecting networks 104 for exchange of user traffic. Each member of visited network group 100 can be a wireless network provider that provides wireless network capacity to end users (subscribers) of one or more wireless network providers of home networks group 102 and hence may be referred to as a visited network. Each member of home networks group 102 can be a wireless network provider that has one or more subscribers (e.g., end users 106) and hence may be referred to as a home network. End users 106 of a given home network can utilize services provided by one or more visited network and thus are shown in association with visited networks group 100 in FIG. 1 indicating that end users 106 are roaming (using wireless network capacities) on one or more visited networks of visited networks group 100.

In one example embodiment, coverage area of a visited network and a home network may overlap. Therefore, it may be desirable for the home network to enter into an exchange with the visited network to offload some of its traffic to visited network to both decrease its own network resource utilization and increase under-utilized resources of the visited network. In another example, a home network may not provide services in a geographical region in which the visited network provides coverage. Therefore, it may be desirable for the home network to enter into an exchange with the visited network to have end users of home network roam on the visited network.

Each one of end users 106 may be an electronic device or component capable of establishing and utilizing wireless network services of a provider. Examples of end users 106 include, but are not limited to, mobile phones, smartphones, tablets, laptops, cameras, any type of known or to be developed Internet of Things (IoT) devices, that utilize the capacity of a seller network provider.

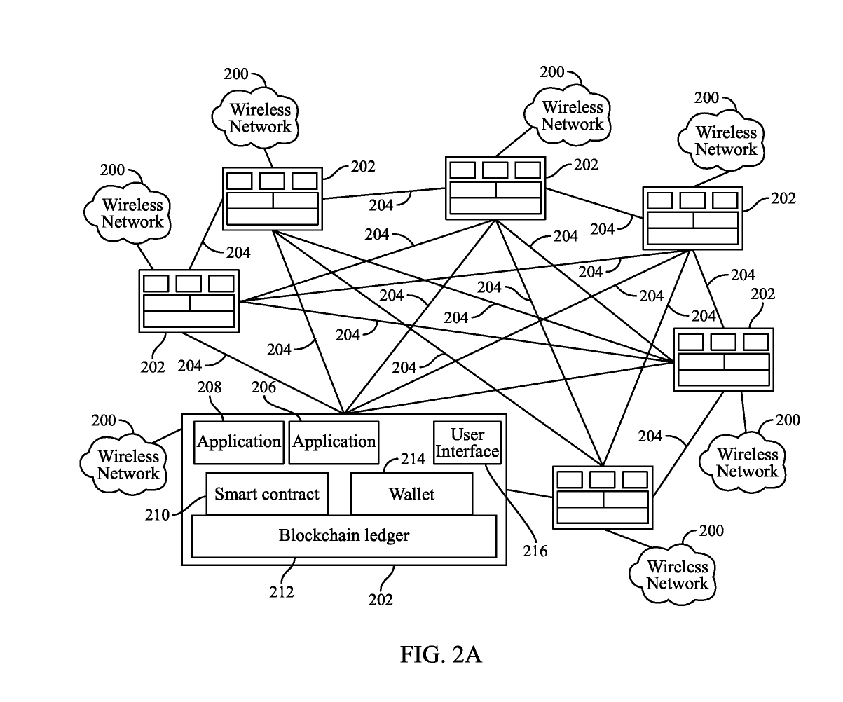

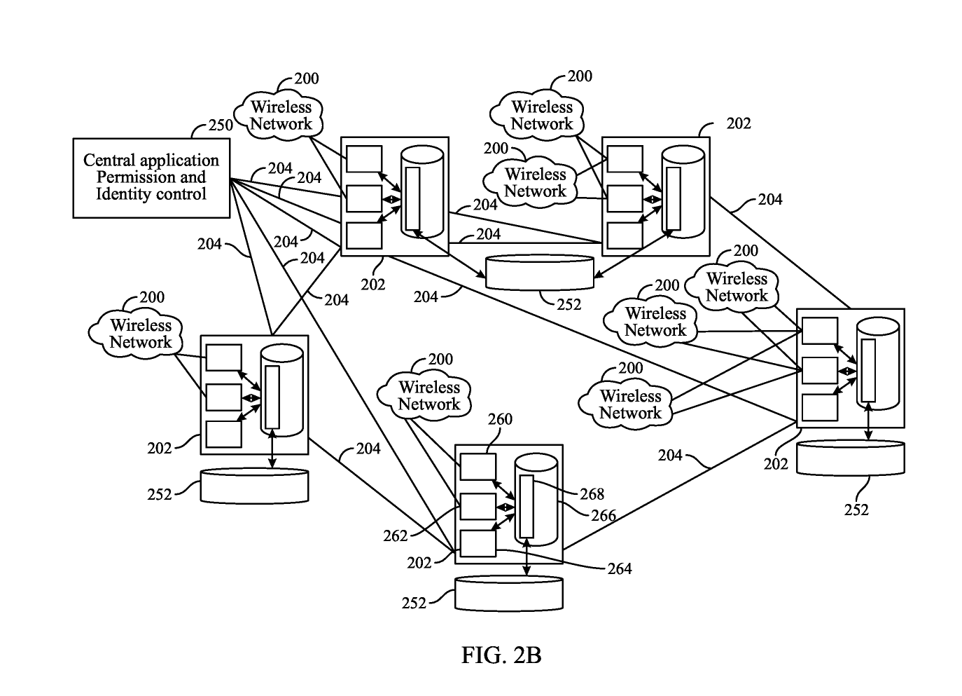

FIG. 2A is an illustrative block diagram of interconnection of components of ecosystem of FIG. 1 for exchange of services.

FIG. 2A illustrates a series of wireless networks 200 each of which may be one of a visited network or a home network described above with reference to FIG. 1. Each of wireless networks 200 of FIG. 2A may be associated with a node 202 on a permissioned blockchain (distributed ledger) system for automated management of exchange of services between wireless networks 200. Nodes 202 are connected to each other via one of links 204 which may be a wireless link.

Each of wireless networks 200 may be a fully autonomous wireless service provider configured to provide wireless services to one or more user devices within a confined premise such as a building, a group of buildings in close proximity to each other, a group of buildings commonly owned but dispersed across multiple geographical locations, etc.

FIG. 2A illustrates an enlarged one of nodes 202 and components thereof. As shown, each node 202 includes one or more computer-executable applications 206 and 208. One or more computer-executable applications 206 may be used to manage offering, negotiating, and finalization of smart contracts 210 and the recording of same on a blockchain ledger (distributed ledger) 212, according to any known or to be developed method of recoding content on a blockchain.

Each node may also have one or more computer-readable applications 208 which interface and communicate with corresponding wireless network 200 to manage access control and enforce the terms of the smart contract using various methods and interfaces available within wireless networks. These applications receive information from corresponding wireless network 200 regarding services by corresponding wireless network 200. This information may include, but is not limited to, such aspects as the number of end users served by corresponding wireless network 200, location covered by corresponding wireless network 200 and where end users were served, the amount of wireless services provided by corresponding wireless network 200, quality of the services provided by corresponding wireless network 200, etc.

Each node has one or more digital wallet application 214 that include any currently known or to be developed cryptocurrency that may be considered as an acceptable payment tool for exchanged services between two contracting wireless service providers 200. Payment transactions are recorded on blockchain ledger 212. In another example, payment for exchanged services may be made by payment methods other than cryptocurrencies such as other known or to be developed financial instruments such as credit cards, etc.

Each node 202 may also have an associated interface 216 and related functions allowing an operator of corresponding wireless network 200, to provide terms for an exchange, accept offers of terms for an exchange, the parameters by which the node will interact with the other nodes regarding smart contracts, presentation of information regarding the provisioning of services, etc.

In FIG. 2A, collection of nodes 202 can be considered a platform that enables automated creation, management and execution of an exchange of wireless services between two or more wireless service providers, as will be described below.

In FIG. 2A, the entire process from broadcasting messages expressing intent of wireless networks 200 to enter into an exchange of wireless network resources and services, to finalizing terms and conditions of an exchange to management and monitoring implementation of an exchange to finally settlement thereof, is performed in a peer-to-peer fashion between two or more wireless networks 200 that are parties to the underlying exchange.

With one example of interconnection of network components of ecosystem of FIG. 1 shown in FIG. 2A, FIG. 2B provides another example of interconnection of network components.

FIG. 2B is an illustrative block diagram of interconnection of components of ecosystem of FIG. 1 for exchange of services. Same components in FIGS. 2A and 2B have the same numerical reference number.

FIG. 2B illustrates a series of wireless networks 200, similar to FIG. 2A, each of which may be one of a visited network or a home network described above with reference to FIG. 1. Each of wireless networks 200 may be a fully autonomous wireless service provider configured to provide wireless services to one or more user devices within a confined premise such as a building, a group of buildings in close proximity to each other, a group of buildings commonly owned but dispersed across multiple geographical locations, etc.

Each of wireless networks 200 of FIG. 2A may be associated with a node 202 on a permissioned blockchain (distributed ledger) system for automated management of exchange of services between wireless networks 200. Nodes 202 are connected to each other via one of links 204 which may be a wireless link.

As shown in FIG. 2B and unlike the setup of FIG. 2A, in which there was a one to one correspondence between each wireless network 200 and each node 202, in FIG. 2B there may be more than one wireless network 200 associated with a given node 202.

FIG. 2B further illustrates a central application permission and identity control component 250, which may hereinafter be referred to as controller 250. In one example, controller 250 may facilitate broadcasting of messages that inform wireless networks 200 of availability of roaming services (network resources) of one or more seller networks 200, broadcasting of messages that inform wireless networks 200 that one or more buyer networks 200 are seeking roaming services of other wireless networks 200, negotiation of terms and conditions for an exchange/roaming service between two or more wireless networks 200, etc.

In setup of FIG. 2B, while controller 250 may handle the above described facilitation of broadcasting of messages, negotiations of terms and conditions, etc., once an exchange between two or more wireless service providers are finalized, the implementation of an exchange, monitoring and settlement thereof may be performed directly by the wireless service providers that are parties to the exchange without involvement of controller 250. In other words, in FIG. 2B, setting up, negotiating and finalizing an exchange may be performed centrally via controller 250, while implementation, monitoring and settlement of exchanges are performed in a peer-to peer fashion by the contracting wireless networks 200.

Links 204, which may facilitate wireless and/or wired communication of various components of FIG. 2B to any other component of FIG. 2B may be the same as links 204 described above with reference to FIG. 2A.

Each node 202 of FIG. 2B may have a distributed storage node 252 associated therewith, which together form a database for storing various information regarding exchanges between wireless networks. By utilizing a network of distributed storage nodes 252, each node 202 does not need to keep record of exchanges and may simply store a pointer to a location in distributed storage nodes 252 at which corresponding data is stored.

As shown in FIG. 2B, there may be more than one node 202 associated with a given distributed storage node 252.

Nodes 202 each may have components including an access control node 260 (a client node) providing access control to corresponding wireless network(s) 200, a reporting node 262 for reporting various types of information regarding exchanges to corresponding wireless network(s) 200, a validation node 264 for validating chain code 268, exchanges, payments for exchanges, etc. before such information is recorded on the distributed ledger system, a fabric ledger 266 having chain code 268 for recording information about exchanges onto the distributed ledger system (e.g., blockchain). Components 260, 262, 264, 266 and 268 have been referenced in FIG. 2B for one of nodes 202 but it is readily ascertainable that each such component exists on each of nodes 202.

Having described examples of ecosystem 100 and components thereof with reference to FIGS. 2A-B, the disclosure now turns to description of an example method for creating, managing and settlement of wireless service exchanged between two or more wireless network providers.

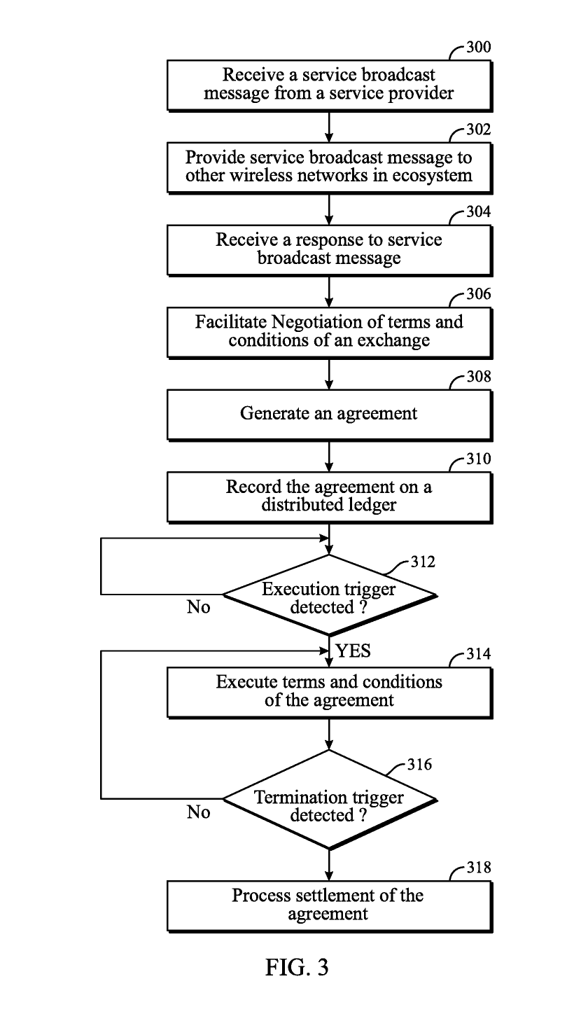

FIG. 3 is an example method of creating, managing and settlement of wireless service exchanges between two or more wireless network providers. FIG. 3 will be described from perspective of a given node 202 of FIG. 2A. However, it will be understood that each node 202 may have one or more processors having computer-readable instructions stored thereon, which when executed by one or more processors, allow node 202 to perform steps of FIG. 3 as will be described below. Furthermore, FIG. 3 will be described with reference to FIGS. 1 and 2A-B. Furthermore, within example structure of FIG. 2B, one or more steps of FIG. 3 may be performed by controller 252 while other steps may be performed by corresponding nodes 202. For example, steps S300 to S310 of FIG. 3, which will be described below, may be performed by controller 252 while remaining steps S312 to S318 may be performed by corresponding node(s) 202 (associated with parties to an agreed upon exchange).

At S300, node 202 may receive a service broadcast message from corresponding wireless network 200 (first wireless network or first wireless service provider) associated with such node 202, as shown in FIG. 2A. Corresponding wireless network 202 may belong to visited networks group 100, in which case, service broadcast message of S300 may be a message by such visited network advertising availability of its wireless network resources for roaming thereon by end users of home network from home networks group 102.

In another example, corresponding wireless network 202 may belong to home networks group 102, in which case, service broadcast message of S300 may be a message by such home network advertising its willingness to enter into an exchange with a visited network to have its associated end users to utilize network capacities of the visited network.

In one example, the service broadcast message may be provided by an operator of corresponding wireless network 200 via user interface 216 and one or more of applications 206. In another example, such service broadcast message may be generated and sent to node 202 automatically by corresponding wireless network 200. For example, when corresponding wireless network 200 is a home network, it may determine that utilization of its network resources are greater than a threshold such that partial offloading of its end users to use network resources of a visited wireless network is desired. Accordingly, corresponding wireless network 200 may automatically generate the service broadcast message to seek usage of network resources of one or more visited wireless networks. The threshold may be a configurable parameter determined based on experiments and/or empirical studies.

In another example, when corresponding wireless network 200 is a visited network, it may determine that utilization of its network resources are significantly lower than a threshold or it may determine higher than average end user footprint within its vicinity. Accordingly, corresponding wireless network 200 may automatically generate the service broadcast message to inform any home network that corresponding wireless network 200's network resources may be utilized by end users of such home networks. In another example, a visited wireless network with available resources may continuously or periodically advertise availability of its network resources to potential interested home networks within the ecosystem.

At S302, node 202 may take the received service broadcast message and transmit (provide) the message to other wireless networks 200 within the ecosystem, which may be received at corresponding nodes 202 of the other wireless networks 200. This transmission may be performed according to any known or to be developed wired and/or wireless transmission protocol.

At S304, node 202 may receive a response to the service broadcast message from another wireless network 202 (second wireless network or second wireless service provider). A service broadcast message may include a set of terms and conditions. For example, when the service broadcast message is generated by a visited wireless network, the message may include information such as location in which wireless services by such visited wireless network is provided (where examples of location include a confined geographical area such as one or more buildings, a limited open space area, etc.), quality of service, routine type, public and private keys, service measurement metrics based on which price of services is determined such as price per megabyte of usage per minute (unit of time), time period for validity of services, payment terms and accepted methods of payment, types of end users accepted for service, etc.

When the service broadcast message is generated by a home network seeking partners to have its end users roam thereon, the message may include information such as location in which wireless services are desired, quality of service desired, routine type, public and private keys, service measurement metrics based on which price of services is determined such as price per megabyte of usage per minute (unit of time) that home network is willing to pay, time period for validity of services sought by the home network, payment terms and available methods of payment, types of end users to be serviced, total/aggregate traffic in megabytes, number of unique users, etc.

Accordingly, at S304, node 202 may receive a response that accepts terms and conditions included in the received service broadcast message or may receive a “counter offer” to terms and conditions included in the received service broadcast message.

At S306, node 202 may facilitate (enable) negotiation of terms and conditions of an exchange between home and service network providers from which the service broadcast message and the response are received. In each of the service broadcast message and the response, there may be an acceptable range associated with each parameter. For example, there may be a range of quality of service acceptable to a home network for its end users. Furthermore, there may be price range for data usage that is acceptable to a home network. Similarly, there may be a price range for data usage offered by a visited wireless network. Accordingly, at S306, node 202 facilitates negotiation of home and visited wireless networks to come to an agreement on various terms based on various set ranges by each side for different parameters.

In one example, the negotiation of terms and conditions may be carried out automatically and without further input from an operator of either the home network or the visited wireless network. For example, over time data may be collected by each node 202 about various types of services offered by each home network node to its subscribers and end users, historical data on exchanges entered into by home and visited wireless networks, market conditions and historical fluctuations related to pricing of wireless network resources, etc. Such data may be stored in a single or a distributed network of databases accessible by any given one of nodes 202. Furthermore, such data may be fed into a machine learning algorithm that can, over time, learn and predict behavior, preferences and reasonable terms and conditions for exchanges between any given home wireless network and any given visited wireless network. Therefore, output of such machine learning algorithm may be used to facilitate and finalize terms and conditions of an exchange between a home wireless network and a visited wireless network at S306.

Thereafter, at S308, node 202 generates a recording of the terms and conditions for an exchange of wireless network services between a home network and a visited home network. In one example, the steps of S300 to S308 may collectively be referred to as generation of a smart contract for exchange of wireless network services between a home network and a visited home network.

At S310, node 202 records the agreement (the smart contract) on a distributed ledger (e.g., a blockchain described above with reference to FIGS. 2A-B) according to any known or to be developed method.

At S312, node 202 determines if a triggering condition (execution trigger) for execution of terms and conditions of the agreement have been detected. In one example, a triggering condition can be detection of presence of any one or more end users of a home network that is a party to the agreement in coverage area of a visited network that is the other party to the agreement. Another example of a triggering condition can be an agreed upon date (including validation or enforcement period) and time frame for the exchange between the home and visited networks.

If at S312, node 202 determines that no triggering condition is detected, then S312 is repeated (continuously or periodically (e.g., every few seconds, minutes, hours, etc.)) until a triggering condition is detected.

Once a triggering condition is detected at S312, at S314, node 202 executes appropriate ones of terms and conditions of the agreement as applicable. For example, data usage by end users of home network roaming on the visited network may be monitored.

At S316, node 202 determines if another triggering condition (termination trigger) has been detected for terminating execution of terms and conditions of the agreement. Such triggering condition can be a determination that one or more end users of home network have stopped roaming (are no longer detected) on the visited network. Another triggering condition can be a termination date specified as part of the terms and conditions within the agreement.

If at S316, a termination trigger is not detected, node 202 repeats S314 and S316 until a termination trigger is detected. Once a termination trigger is detected, at S318, node 202 automatically settles (process payment) for the exchange based on terms and conditions of the agreement using any type of agreed upon payment method including cryptocurrencies (e.g., bitcoin, ethereum, etc.), credit cards, etc.

In another example, settlement for an exchange may be performed several times throughout the execution of the exchange (while the exchange of services is active). For example, network resources and roaming services provided by a visited network may be reported hourly (periodically) and recorded on the distributed ledger. Furthermore, an agreed upon exchange may specify that settlement should be carried out every specified period of time (e.g., every 24 hours). Accordingly, at expiration of each 24 hours period (as agreed upon), reported hourly usages for the 24 hour period may be aggregated, pricing thereof determined according to terms and conditions of the exchange and settled accordingly.

Implementing example process of FIG. 3 for creating, managing and execution a smart contract for an exchange of wireless network services may provide the following advantages. Using the distributed ledger system to record an entire life cycle of a smart contract or agreement (including creation, terms and conditions, execution and method of payment) can create a reputable record for each wireless network provider including but not limited to, quality of services provided by a visited network, whether a particular home network or visited network honored terms and conditions of an exchange, timely payment for services by a given home network for roaming services provided by a visited network to home network's end users, etc.

In one example, a “reputation” score may be assigned to each wireless network. Because any given wireless network can act as a home network in one instance and as a visited network in another, a home reputation score and a visited reputation score may be assigned to each wireless network 200. For example, a home reputation score may be indicative of how timely a home network has paid for roaming services provided by a visited network to its end users. In another example, a visited reputation score may be indicative of the quality of roaming services provided by a corresponding wireless network to end users of a home network.

In one example, the platform provided by the collection of nodes 202 may take such scores into consideration in determining pricing and/or other terms and conditions of services in the agreement. For example, a roaming service provided to a home network with a perfect home reputation score may be priced lower (be eligible for discounts) relative to the same roaming service with a relatively lower home reputation score due to delinquent payment history, late payments in the past, etc.

Furthermore, such scores may be taken into consideration by any given home network or visited network, when deciding to enter into negotiations for an exchange. In other words, different exchanges between different wireless networks 200 may be different (dynamically adjusted) by further, in addition to factors and negotiated terms described above, taking into consideration each wireless network's reputation score (home reputation score or visited reputation score, as applicable).

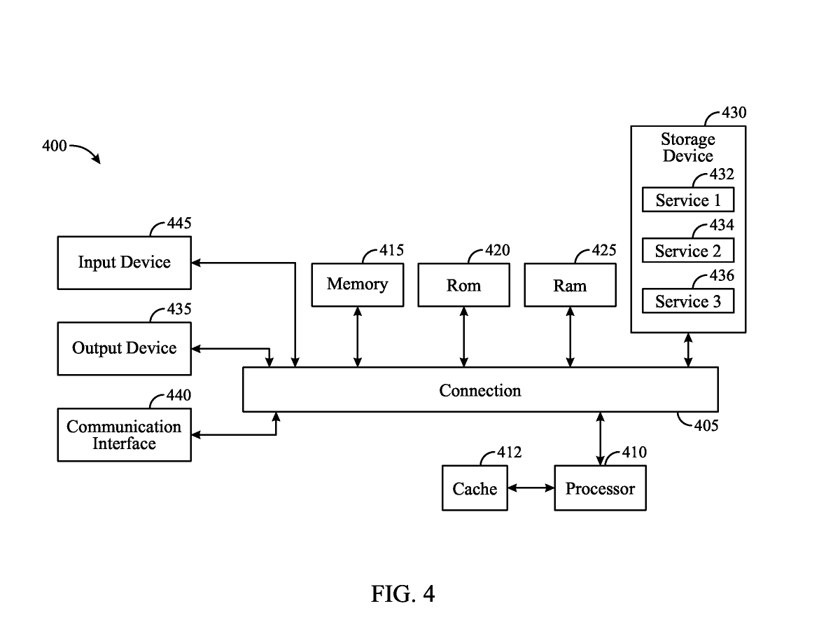

Having described various examples of creation, management and execution of agreements for exchange of wireless communication services, various components of an example node 202 that carries out process of FIG. 3, will be described with reference to FIG. 4.

FIG. 4 illustrates example components of a node of FIGS. 2A-B.

In this example, FIG. 4 illustrates a computing system 400 including components in electrical communication with each other using a connection 405, such as a bus. System 400 includes a processing unit (CPU or processor) 410 and a system connection 405 that couples various system components including the system memory 415, such as read only memory (ROM) 420 and random access memory (RAM) 425, to the processor 410. The system 400 can include a cache of high-speed memory connected directly with, in close proximity to, or integrated as part of the processor 410. The system 400 can copy data from the memory 415 and/or the storage device 430 to the cache 412 for quick access by the processor 410. In this way, the cache can provide a performance boost that avoids processor 410 delays while waiting for data. These and other modules can control or be configured to control the processor 410 to perform various actions. Other system memory 415 may be available for use as well. The memory 415 can include multiple different types of memory with different performance characteristics. The processor 410 can include any general purpose processor and a hardware or software service, such as service 1 432, service 2 434, and service 3 436 stored in storage device 430, configured to control the processor 410 as well as a special-purpose processor where software instructions are incorporated into the actual processor design. The processor 410 may be a completely self-contained computing system, containing multiple cores or processors, a bus, memory controller, cache, etc. A multi-core processor may be symmetric or asymmetric. The storage device 430 can be local and directly attached to connection 405 or can be located far away and communicatively coupled to other components of system 400.

To enable user interaction with system 400, an input device 445 can represent any number of input mechanisms, such as a microphone for speech, a touch-sensitive screen for gesture or graphical input, keyboard, mouse, motion input, speech and so forth. An output device 435 can also be one or more of a number of output mechanisms known to those of skill in the art. In some instances, multimodal systems can enable a user to provide multiple types of input to communicate with system 400. The communications interface 440 can generally govern and manage the user input and system output. There is no restriction on operating on any particular hardware arrangement and therefore the basic features here may easily be substituted for improved hardware or firmware arrangements as they are developed.

Storage device 430 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 425, read only memory (ROM) 420, and hybrids thereof.

The storage device 430 can include services 432, 434, 436 for controlling the processor 410. Other hardware or software modules are contemplated. The storage device 430 can be connected to the system connection 405. In one aspect, a hardware module that performs a particular function can include the software component stored in a computer-readable medium in connection with the necessary hardware components, such as the processor 410, connection 405, output device 435, and so forth, to carry out the function.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” refers to at least one of a set and indicates that one member of the set or multiple members of the set satisfy the claim. For example, claim language reciting “at least one of A and B” means A, B, or A and B.

Example embodiments of the present disclosure may be provided as a computer program product, which may include a computer-readable medium tangibly embodying thereon instructions, which may be used to program a computer (or other electronic devices) to perform a process. The computer-readable medium may include, but is not limited to, fixed (hard) drives, magnetic tape, floppy diskettes, optical disks, compact disc read-only memories (CD-ROMs), and magneto-optical disks, semiconductor memories, such as ROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware). Moreover, embodiments of the present disclosure may also be downloaded as one or more computer program products, wherein the program may be transferred from a remote computer to a requesting computer by way of data signals embodied in a carrier wave or other propagation medium via a communication link (e.g., a modem or network connection).

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” a set indicates that one member of the set or multiple members of the set satisfy the claim. For example, claim language reciting “at least one of A and B” means A, B, or A and B.

What is claimed is:

1. A distributed ledger system for facilitating an exchange among wireless service providers, the distributed ledger system comprising:
a plurality of wireless service providers, each wireless service provider being one of a home wireless network provider having a corresponding number of end users or a visited wireless network provider having wireless communication capacities for one or more of the end users to roam on; and
a plurality of nodes, each of which is associated with one or more of the plurality of wireless service providers, each of the plurality of nodes being configured to:
receive a service broadcast message from a corresponding first wireless service provider for an exchange of wireless communication services with a second wireless service provider;
enable negotiation of terms and conditions of the exchange between the first wireless service provider and the second wireless service provider;
generate a recording of the terms and conditions of the exchange between the first wireless service provider and the second wireless service provider to yield an agreement;
record the agreement on the distributed ledger system;
detect a triggering condition for executing the terms and conditions;
execute the terms and conditions upon detecting the triggering condition; and
automatically settle the exchange using a cryptocurrency.

2. The distributed ledger system of claim 1, wherein the first wireless service provider is a fully autonomous wireless service provider configured to provide wireless services to one or more user devices within a confined premise.

3. The distributed ledger system of claim 2, wherein a coverage area of the second wireless overlaps with a coverage area of the first wireless service provider within the confined premise.

4. The distributed ledger system of claim 1, wherein the second wireless service provider is configured to offload corresponding user traffic data to a network of the first wireless service provider based on the agreement.

5. The distributed ledger system of claim 1, wherein information in the service broadcast message include one or more of:
location of coverage provided by the first wireless service provider;
quality of service of the coverage provided by the first wireless service provider;
time frame associated with availability of the coverage provided by the first wireless service provider;
measurement metrics for the coverage provided by the first wireless service provider;
pricing information associated with the measurement metrics; and
accepted payment methods by the first wireless service provider.

6. The distributed ledger system of claim 1, wherein the triggering condition is detection of a user device associated with the second wireless service provider in coverage area of the first wireless service provider.

7. The distributed ledger system of claim 1, wherein the terms and conditions are in part based on respective reputation score of each of the first wireless service provider and the second wireless service provider.

8. The distributed ledger system of claim 1, wherein each of the plurality of nodes is configured to enable negotiation of terms and conditions of the exchange using machine learning based analysis of past exchanges entered into by the first wireless service provider and the second wireless service provider, corresponding exchanges of each of the first wireless service provider and the second wireless service provider with third party providers, and market conditions associated with exchanges between any two wireless service provider.

9. A distributed ledger system for facilitating an exchange among service providers, the system comprising:
one or more servers to which a plurality of service providers subscribe, the one or more servers configured to execute computer-readable instructions to:
enable a first service provider to broadcast a message requesting information on available service providers in a geographical region for offloading user traffic of the first service provider thereon, the message including offered terms for the exchange;
enable a second service provider within the geographical region to respond to the message to (1) accept the offered terms or (2) provide alternative terms for the exchange; and
a server configured to execute an application to:
finalize mutually agreed upon terms of the exchange between the first service provider and the second service provider;
generate a recording of the mutually agreed upon terms to yield an agreement;
record the agreement on the distributed ledger system;
detect a triggering condition for executing the terms and conditions;
execute the terms and conditions upon detecting the triggering condition; and
automatically settle the exchange using a cryptocurrency.

10. The distributed ledger system of claim 9, wherein the first service provider has a plurality of subscribers and is configured to provide wireless services to the subscribers over a first geographical area.

11. The distributed ledger system of claim 10, wherein the second service provider is a fully autonomous wireless service provider configured to provide wireless services to one or more user devices within a second geographical area that is smaller than the first geographical area.

12. The distributed ledger system of claim 9, wherein the first service provider is configured to offload corresponding user traffic data to a network of the second service provider based on the agreement.

13. The distributed ledger system of claim 9, wherein the agreement includes at least one of:
location information of area in which user traffic data of the first service provider is to be offloaded to a network of the second service provider;
quality of service of a coverage to be provided by the second service provider;
time frame for offloading of the user traffic data to the network of the second service provider;
measurement metrics based on which the second service provider is to charge the first service provider for the coverage;
pricing information associated with the measurement metrics; and
accepted payment methods for settling the charge.

14. The distributed ledger system of claim 9, wherein the triggering condition is detection of a user device associated with the first service provider in coverage area of the second service provider. Date and time.

15. The distributed ledger system of claim 1, wherein the triggering condition is execution date and time of the exchange specified by the terms and conditions of the exchange.

16. The distributed ledger system of claim 9, wherein the server is configured to negotiate terms and conditions of the exchange using machine learning based analysis of past exchanges entered into by the first service provider and the second service provider, corresponding exchanges of each of the first service provider and the second service provider with third party service providers, and market conditions associated with exchanges between any two service provider.

17. One or more non-transitory computer-readable media having computer-readable instructions, which when executed by one or more processors, cause the one or more processors to provide a distributed ledger platform for automating service exchanges between two or more of a plurality of service providers by:
broadcasting, by a first service provider, a message requesting information on available service providers in a geographical region for offloading user traffic of the first service provider thereon, the message including offered terms for the exchange;
enabling a second service provider within the geographical region to respond to the message to (1) accept the offered terms or (2) provide alternative terms for the exchange;
finalizing mutually agreed upon terms of the exchange between the first service provider and the second service provider;
generating a recording of the mutually agreed upon terms to yield an agreement;
recording the agreement on the distributed ledger platform;
detecting a triggering condition for executing the terms and conditions;
executing the terms and conditions upon detecting the triggering condition; and
automatically settling the exchange using a cryptocurrency.

18. The one or more non-transitory computer-readable media of claim 17, wherein the first service provider has a plurality of subscribers and is configured to provide wireless services to the subscribers over a first geographical area.

19. The one or more non-transitory computer-readable media of claim 18, wherein the second service provider is a fully autonomous wireless service provider configured to provide wireless services to one or more user devices within a second geographical area that is smaller than the first geographical area.

20. The one or more non-transitory computer-readable media of claim 18, wherein the execution of the computer-readable instructions by the one or more processors cause the one or more processors to negotiate terms and conditions of the exchange using machine learning based analysis of past exchanges entered into by the first service provider and the second service provider, corresponding exchanges of each of the first service provider and the second service provider with third party service providers, and market conditions associated with exchanges between any two service provider.
